(19) United States
(12) Patent Application Publication
(10) Pub. No.: US 2024/0424618 A1
(43) Pub. Date: Dec. 26, 2024

(54) FABRICATION SYSTEM FOR THE MANUFACTURE OF A SUPPORT FRAME FOR A PRESSURE VESSEL, AND METHOD OF MANUFACTURE OF A SUPPORT FRAME FOR A PRESSURE VESSEL WITH PROVISION OF SUCH FABRICATION SYSTEM

(71) Applicant: BAE SYSTEMS PLC, London (GB)

(72) Inventor: Stuart Cartmell, Barrow-in-Furness Cumbria (GB)

(73) Assignee: BAE SYSTEMS PLC, London (GB)

(21) Appl. No.: 18/705,072

(22) PCT Filed: Oct. 10, 2022
(86) PCT No.: PCT/GB2022/052559

§ 371 Date: Apr. 26, 2024

(30) Foreign Application Priority Data
Oct. 27, 2021 (GB) 2115430.7

(51) Int. Cl. B23K 37/04; B23K 101/12; B63B 73/43; B63G 8/04

(52) U.S. Cl. CPC B23K 37/04; B23K 2101/12; B63B 73/43; B63G 8/04

(57) ABSTRACT

A fabrication system (100) for the manufacture of a support frame (10) for a pressure vessel (12). The support frame (10) is fabricated from a plurality of sub-elements (202, 204). The fabrication system comprises a jig assembly (300), a clamping system (400) mounted on the jig assembly (300) and the jig assembly (300) being rotatably mounted about a rotation axis (302), and extending out radially from the rotation axis (302) to an outer edge (304). A plurality of workstations (600, 602, 604) are arranged around the outer edge (304) of the jig assembly (300), located and configured to perform operations on the sub-elements (202, 204). The plurality of workstations (600, 602, 604) are mounted in a fixed position, the jig assembly (300) being rotatable about the rotation axis (302) relative to the workstations (600, 602, 604).

### FIELD

The present disclosure relates to a fabrication system.

In particular the disclosure is concerned with a fabrication system for the manufacture of a support frame for a pressure vessel.

### BACKGROUND

Pressure vessels often comprise a shell which is reinforced with support frames 10 which act as ribs to help maintain the shape of the shell. An example of a section of such a pressure vessel 12 is shown in FIG. 1. The shell may be assembled with other sections to form a complete structure.

For large pressure vessels (for example submarines and submersibles) such support frames 10 can have a very large diameter, and consequently are made from a number of sub-elements joined together. The support frame 10 and sub-elements are large and unwieldly, and conventionally all of the preparation, joining and finishing is done by hand.

Hence the current manufacturing process for support frames requires a large amount of manual handling, manual welding and manual machining of the sub-elements, which is time consuming and relies on consistent human skill. Since the parts are large, it is inevitable that each manufacturing step will not be concluded before another operator takes over. This can result in variability of style and quality of work, which may require time consuming and costly rework, or at least produce a support frame with varied properties around its circumference.

Hence a fabrication system which is able to provide consistent results to the desired quality with less reliance on manual interaction and variation of the process, is highly desirable.

### SUMMARY

According to the present disclosure there is provided an apparatus, system and method as set forth in the appended claims. Other features of the invention will be apparent from the dependent claims, and the description which follows.

Hence there may be provided a fabrication system (100) for the manufacture of a support frame (10) for a pressure vessel (12). The support frame (10) may be fabricated from a plurality of sub-elements (202, 204). The fabrication system may comprise a jig assembly (300) and a clamping system (400) mounted on the jig assembly (300). The clamping system (400) may be configured to support each of the sub-elements (202, 204) individually relative to one another, and to allow movement of the sub-elements (202, 204) relative to one another to position them in a predetermined/desirable orientation relative to one another. The jig assembly (300) may be rotatably mounted about a rotation axis (302), and extending out radially from the rotation axis (302) to an outer edge (304). The jig assembly (300) may comprise a plurality of workstations (600, 602, 604) arranged around the outer edge (304) of the jig assembly (300), located and configured to perform operations on the sub-elements (202, 204) to prepare them for being joined to one another, to join them to one another to form an assembly (222) of the sub-elements (202, 204) and/or to remove material from the sub-element assembly (222) to produce the desired geometry of the support frame (10). The plurality of workstations (600, 602, 604) are mounted in a fixed position, the jig assembly (300) being rotatable about the rotation axis (302) relative to the workstations (600, 602, 604).

The jig assembly (300) may have a diameter D, with an outer circumference (312) centred on the rotation axis (302), the sub-elements (202, 204) arranged around the outer circumference (312) of the jig assembly (300).

The clamping system (400) may be configured to support a first sub-element type (202) and a second sub-element type (204) relative to one another, the first sub-element type (202) and a second sub-element type (204) forming a sector element (206) of the support frame (10). The clamping system (400) may be configured to support each sector element (206).

The clamping system (400) may comprise a plurality of clamping units (402) spaced apart around the circumference of the jig assembly (300).

Each clamping unit (402) may comprise a positioning actuator unit (404). The clamping unit (402) may be moveable radially (R1, R2) along the jig assembly (300) relative to the rotation axis (302) by the positioning actuator unit (404).

Each clamping unit (402) may comprise: a first clamping actuator unit (406) which is operable to extend in a first axial direction A1 parallel to the rotation axis (302), and a second clamping actuator unit (408) which is operable to extend in a second axial direction A2 parallel to the rotation axis (302); to thereby clamp a sub-element (202, 204) therebetween. The first axial direction A1 may be opposite to the second axial direction A2.

Each clamping unit (402) may comprise: a stop member (410) provided towards the outer edge (304) of the jig assembly (300); a first clamping actuator unit (414) which is operable to extend in a radial direction away from the rotation axis (302) towards the stop member (410) to thereby clamp a sub-element (202, 204) between the stop member (410) and the first clamping actuator unit (414).

The stop member (410) may comprise a sub-element engagement feature (412) configured to engage with a first side edge (208) of a sub-element (202, 204); the first clamping actuator unit (406) configured to act on an opposing second side edge (210) of the sub-element (202, 204) and to force the sub-element (202, 204) into engagement with the sub-element engagement feature (412).

Each workstation (600, 602, 604) may be configured for a different operation on the sub-elements (202, 204); the operations comprising at least one of:
a. material removal to prepare the sub-elements (202, 204) for welding;
b. welding at least two sub-elements (202, 204) together; and/or
c. material removal from the joined sub-elements (202, 204) assembly (222).

Each workstation (600, 602, 604) may be provided with a different tool, configured to perform a different operation to any other tool.

The fabrication system (100) may be further provided with a measurement system (500) configured to measure the positions of predetermined datum points (502) on at least one of the workstations (600, 602, 604).

There may also be provided a method of manufacture of a support frame (10) for a pressure vessel (12). The method may comprise: providing a fabrication system (100) according to the present disclosure; locating a plurality of first sub-elements (202) towards the outer edge (304) of the jig assembly (300) in a circle centred on the rotation axis (302); rotating the jig assembly (300) around the rotation axis (302) to present, in turn, joins (212) between the located first sub-elements (202) to a workstation (600) comprising a welding system (620) to join first sub-elements (202) together a circular sub-structure (220).

The method may further comprise locating the second sub-elements (204) relative to the circular sub-structure (220) so that the second sub-elements (204) form a circle abutting the circular sub-structure (210).

The method may further comprise rotating the jig assembly (300) around the rotation axis (302), and operating the workstation (600) comprising a welding system (620) to join the second sub-elements (204) to the circular sub-structure (220).

The method of manufacture may further comprise the steps of rotating the jig assembly (300) around the rotation axis (302), and operating the workstation (602) comprising a material removal tool (622) to prepare the sub-elements (202, 204) for welding.

The method of manufacture may further comprise the steps of rotating the jig assembly (300) around the rotation axis (302), and operating the workstation (404) comprising a material removal tool (624) to remove material from the assembly (222) of joined sub-elements (202, 204).

There is thus provided a fabrication system 100, and a method of operation of a fabrication system 100, for the manufacture of a support frame 10 for a pressure vessel 12 from a plurality of sub-elements 202, 204. Such a system is operable to provide support frames 10 to a consistent and desired quality with less reliance on manual interaction.

### BRIEF DESCRIPTION OF THE FIGURES

Examples of the invention will now be described by way of example only with reference to the figures, in which:

FIG. 1 shows an example of a section of a pressure vessel including a support frame which may be manufactured using an apparatus and method according to the present disclosure;

FIG. 2 shows a pre-assembly (i.e. incomplete assembly) of a support frame:

FIG. 3 shows a plan view of a support frame;

FIG. 4 is a plan view illustration of the different elements and assemblies which may make up the support frame;

FIG. 5 shows a plan view of a jig assembly of a fabrication system according to the present disclosure with the location of the support frame elements indicated by a dotted line;

FIG. 6 shows a perspective view of an example of a fabrication system according to the present disclosure;

FIG. 7 shows a plan view of the jig assembly of a fabrication system (as shown in FIG. 5, without the support frame indicated);

FIG. 8 shows an underside view of a part of the jig assembly;

FIG. 9 shows a clamping unit which forms part of the fabrication system;

FIG. 10 shows a different view of the clamping unit;

FIG. 11 shows clamping units mounted to the jig assembly and holding sub-elements of the support frame during fabrication;

FIG. 12 shows a different view of the arrangement shown in FIG. 11;

FIG. 13 illustrates the first workstation of the fabrication system;

FIG. 14 illustrates a third workstation and measuring system of the fabrication system;

FIG. 15 shows a second workstation of the fabrication system; and

FIG. 16 shows a further view of the third workstation shown in FIG. 14.

### DETAILED DESCRIPTION

The present disclosure relates to a fabrication system 100 for the manufacture of a support frame 10 for a pressure vessel 12. The present disclosure also relates to a method of manufacture of a support frame 10 for a pressure vessel 12. The present disclosure also relates to the manufacture of a pressure hull for a pressure vessel.

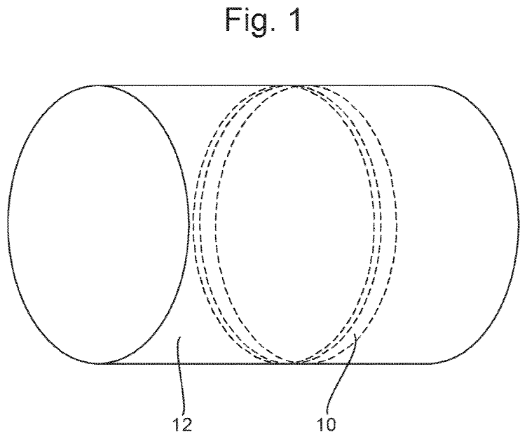

The pressure vessel is illustrated as cylinder in FIG. 1. The pressure vessel 12 of the present disclosure may be a submarine (e.g. a submersible configured to be submerged in water), or a hull section of a submarine which when assembled with other hull sections, forms a water and air tight sealable hull for example a pressure hull. A support frame 10 of the present disclosure may be fixed to the inner surface of the pressure hull of the pressure vessel 12 (as shown in FIG. 1), or to the outer surface of the pressure hull of the pressure vessel 12, to thereby provide the required strength and rigidity required of such a heavy duty piece of equipment.

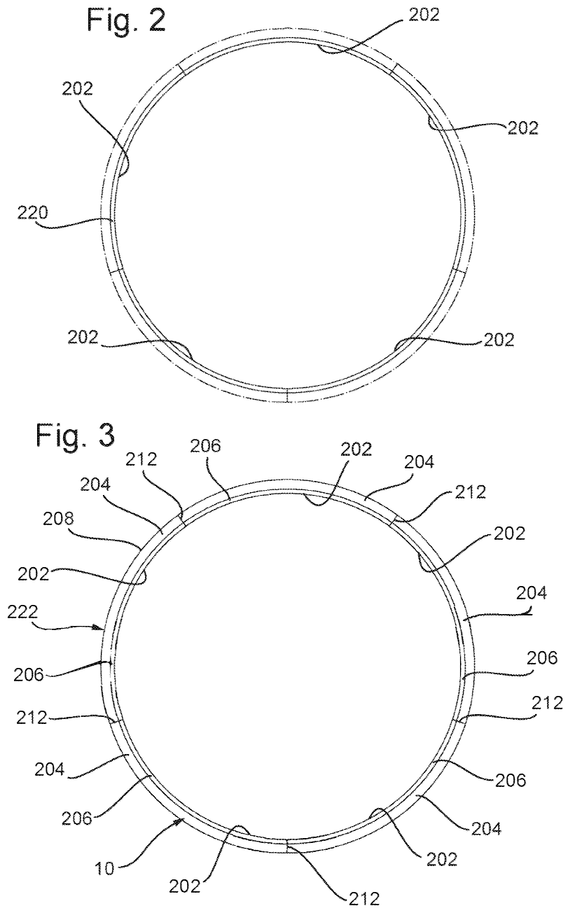

FIGS. 2, 3 and 4 illustrate different aspects of the support frame 10. Since the support frame 10, when finished, has a large diameter, and is typically made of metal, it is fabricated from a plurality sector elements 206 arranged in a circle or ring, for example in as shown in FIG. 3. In the example of FIG. 3 there are provided five sector elements 206 fixed to each other at joints 212 (e.g. by welding). In other examples, the support frame 10 may comprise more or less than five sector elements 206.

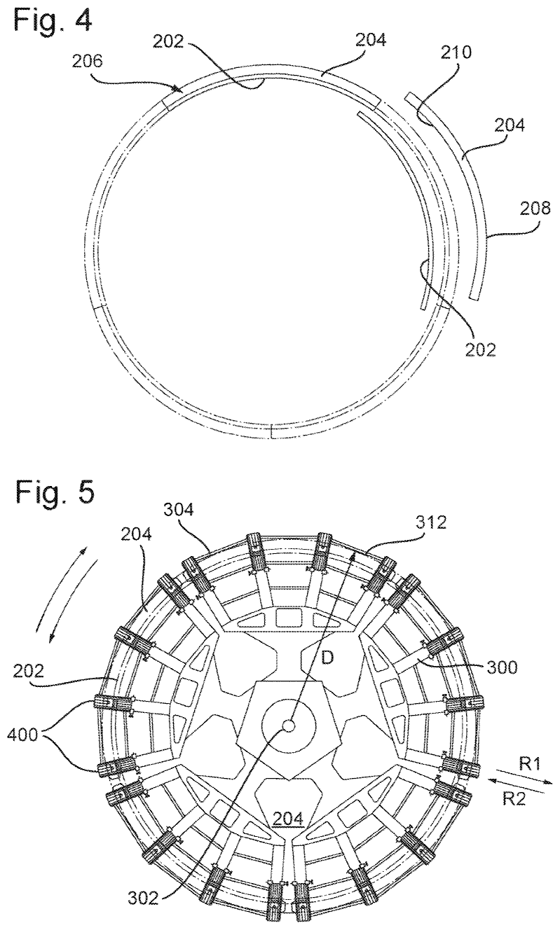

As shown in FIG. 4, each sector element 206 may be fabricated from a first sub-element type 202 and a second sub-element type 204.

The first sub-element 202 may be referred to as a “table” and the second sub-element 204 may be referred to as a “web”.

In the example shown, both the first sub-element type 202 (table) and second sub-element type 204 (web) are provided as a sheet/strip of metal which are curved along their length. Both first sub-element type 202 and second sub-element type 204 have a length, width and thickness, the length being greater than the width, the width being greater than the thickness.

The radially inner surface of the first sub-element 202 defined by the width and length is concave, and the radially outer surface of the first sub-element 202 defined by the width and length is convex. The edges of the first sub-element 202 are flat.

The radially inner edge of the second sub-element 204 is concave, and the radially outer edge the second sub-element 204 is convex. The surfaces of the first sub-element 202 defined by the width and length is flat.

The curvature of the radially inner edge of the second sub-element 204 is the same as the curvature of the radially outer surface of the first sub-element 202, so that they fit together.

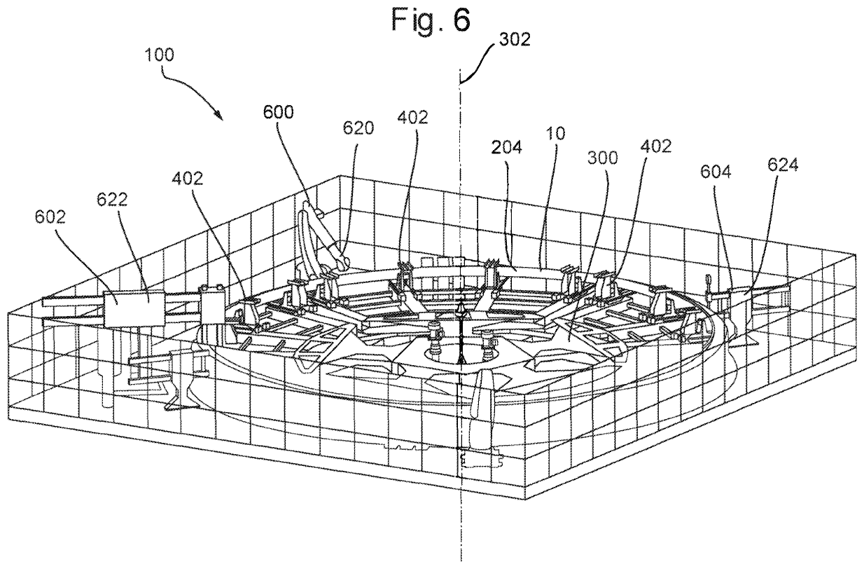

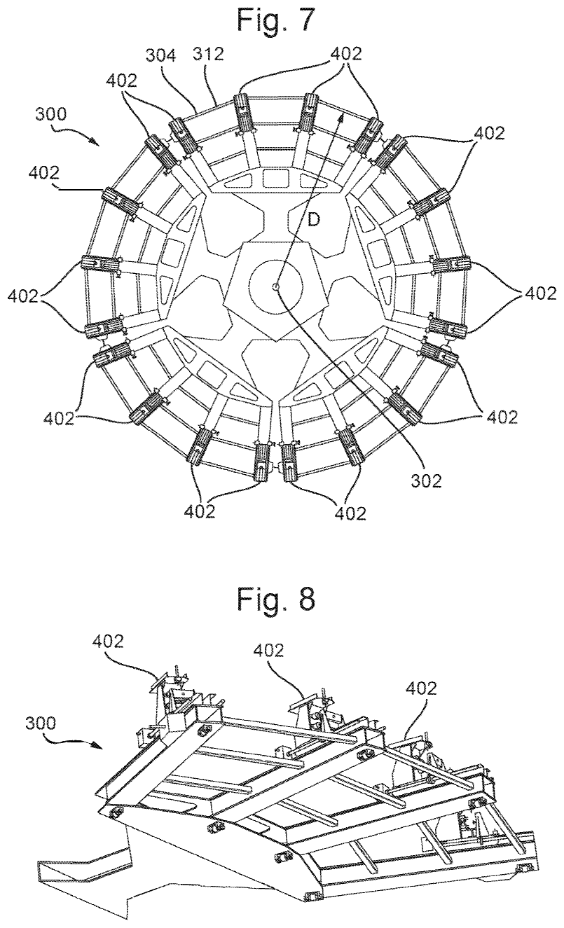

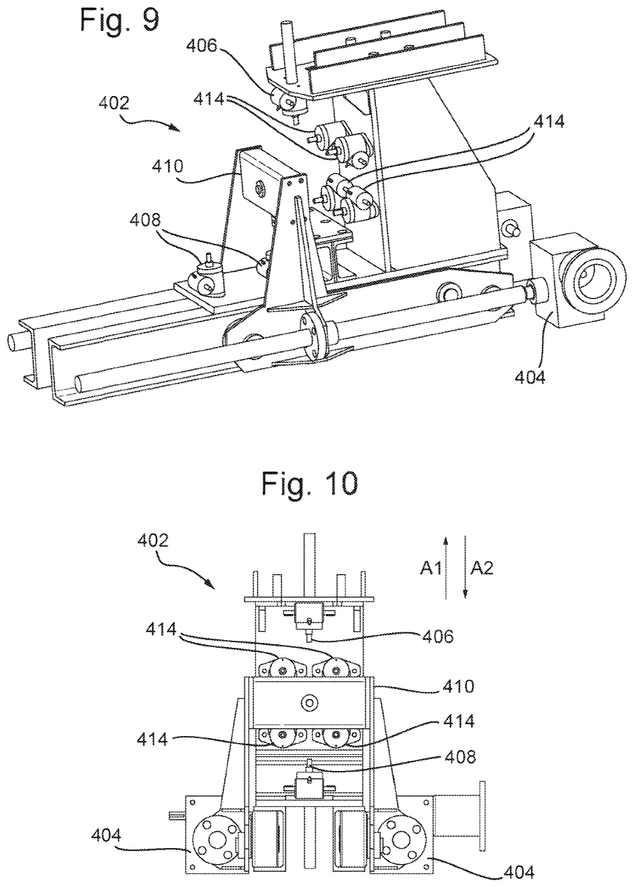

As shown in FIGS. 5 to 7, the fabrication system 10 comprises a jig assembly 300. FIGS. 5, 7 are plan views of the jig assembly 300, where FIG. 5 illustrates how the sub-elements 202, 204 are located on the jig assembly 300 around its edge. FIG. 6 is a perspective view of the jig assembly 300. FIG. 8 shows an underside view of a section the jig assembly 300.

The jig assembly 300 is rotatably mounted about (and centred on) a rotation axis 302, and extends out radially from the rotation axis 302 to an outer edge 304. Hence, in the examples shown, when viewed from above, the jig assembly 300 is circular. The jig assembly 300 may be rotated around the rotation axis by a motor (not shown) with positioning control such that the jig assembly 300 can be rotated past and/or stop at workstations as required.

The fabrication system further comprises a clamping system 400 mounted on the jig assembly 300. As shown in FIGS. 6, 7, the clamping system 400 comprises a plurality of clamping units 402 spaced apart around the edge 304 (e.g. circumference) of the jig assembly 300.

The clamping system 400 may be configured to support each of the sub-elements 202, 204 individually relative to one another. The clamping system 400 may be configured to support each of the sub-elements 202, 204 individually and relative to one another. That is to say, groups of the clamping units 402 are configured to support a first sub-element 202 and a second sub-element 204. The clamping system 400 is thus configured to support each sector element 206. The clamping system 400 may be configured to support each sector element 206 independently of at least one other sector element 206 on the support jig assembly 300. In the example shown in FIGS. 7, 8, groups of four clamping units 402 support a first sub-element 202 and a second sub-element 204. In the examples shown there are five groups of clamping units 402, each group supporting a different pair of sub-elements 202, 204 and/or sector element 206. The clamping system 400 is configured to allow controlled movement (i.e. adjustment of position) of sub-elements 202, 204 relative to one another to locate, and fix, them in the correct orientation relative to one another.

A plurality of workstations 600, 602, 604 are arranged around the outer edge 304 of the jig assembly 300, located and configured to perform operations on the sub-elements 202, 204. For example, one of the operations may be to prepare sub-elements 202, 204 to be joined to one another, for example adding a bevel to the join regions 212. Alternatively or additionally, one of the operations may be to join sub-elements 202, 204 to one another (for example by welding) to form a sector element 206 or an assembly 222 of the sub-elements 202, 204. Alternatively or additionally, one of the operations may be to remove material from a sub-element 202, 204, a sector element 206 and/or an assembly 222 to produce the desired geometry and/or finish of the support frame 10.

The plurality of workstations 600, 602, 604 are mounted in a fixed position, the jig assembly 300 being rotatable about the rotation axis 302 relative to the workstations 600, 602, 604. The plurality of workstations 600, 602, 604 may be mounted to a substrate (e.g. workshop floor) such that they are mounted in a fixed position on the substrate. The jig assembly 300 is rotatable relative to the substrate, and hence rotatable relative to the workstations.

As shown in FIGS. 5, 7, the jig assembly 300 may have a diameter D, with an outer circumference 312 (e.g. edge 304) centred on the rotation axis 302, the sub-elements 202, 204 arranged around the outer circumference 312 (and/or edge 304) of the jig assembly 300.

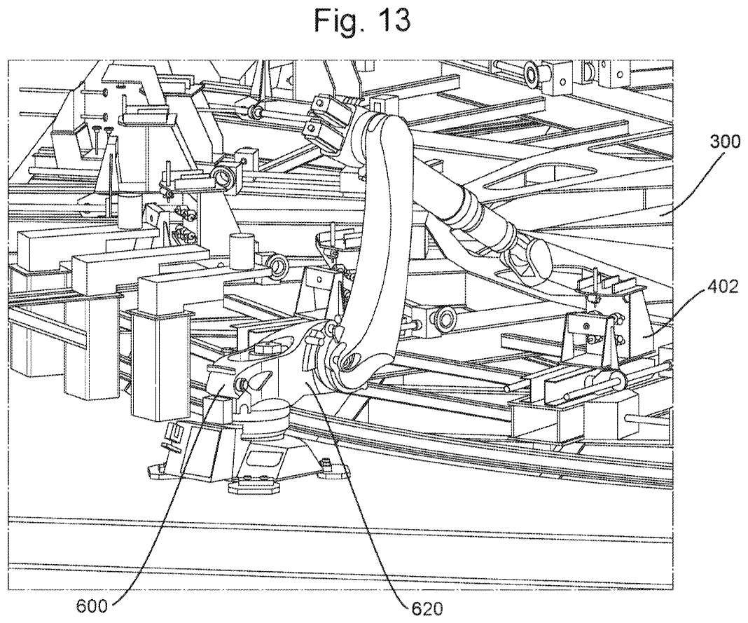

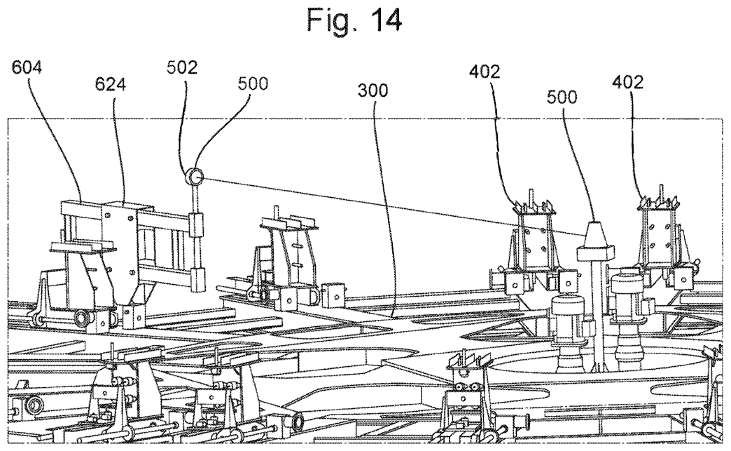

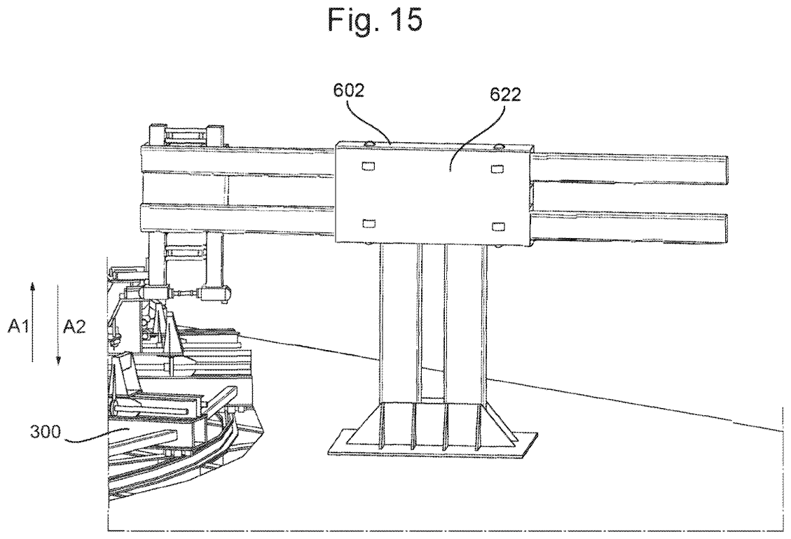

As illustrated in FIGS. 5, 12, the clamping unit 402 is moveable radially (i.e. in opposite directions R1, R2) along an arm of the jig assembly 300 on which it sits, relative to the rotation axis 302. The clamping unit 402 may be operable to move along an arm of the jig assembly 300 on which it sits, away from and/or towards the rotation axis 302. Hence the clamping unit 402 may be operable to move in a first radial direction R1 along an arm of the jig assembly 300 on which it sits away from the rotation axis 302 and/or move in a second radial direction R2 along an arm of the jig assembly 300 on which it sits towards the rotation axis 302.

The clamping unit 402 may be moveable in radial directions R1, R2 along an arm of the jig assembly 300 by a positioning actuator unit 404. That is to say, the clamping unit 402 is moveable radially outward in a direction R1, and radially inward in a direction R2 by the positioning actuator unit 404.

As illustrated in FIGS. 10, 11, 12, each clamping unit 402 may also comprise a first clamping actuator unit 406 which is operable to extend in a first axial direction A1 parallel to the rotation axis 302, and a second clamping actuator unit 408 which is operable to extend in a second axial direction A2 parallel to the rotation axis 302 to thereby clamp a sub-element 202, 204 therebetween (i.e. between the first clamping actuator unit 406 and the second clamping actuator unit 408). Hence the first axial direction A1 is opposite to the second axial direction A2.

Each clamping unit 402 comprises a stop member 410 provided towards (e.g. proximate to) the outer edge 304 of the arm of the jig assembly 300. Each clamping unit 402 may also comprise a first clamping actuator unit 414 which is operable to extend in a radial direction away from the rotation axis 302 (i.e. direction R1) towards the stop member 410 to thereby clamp a sub-element 202, 204 between the stop member 410 and the first clamping actuator unit 414.

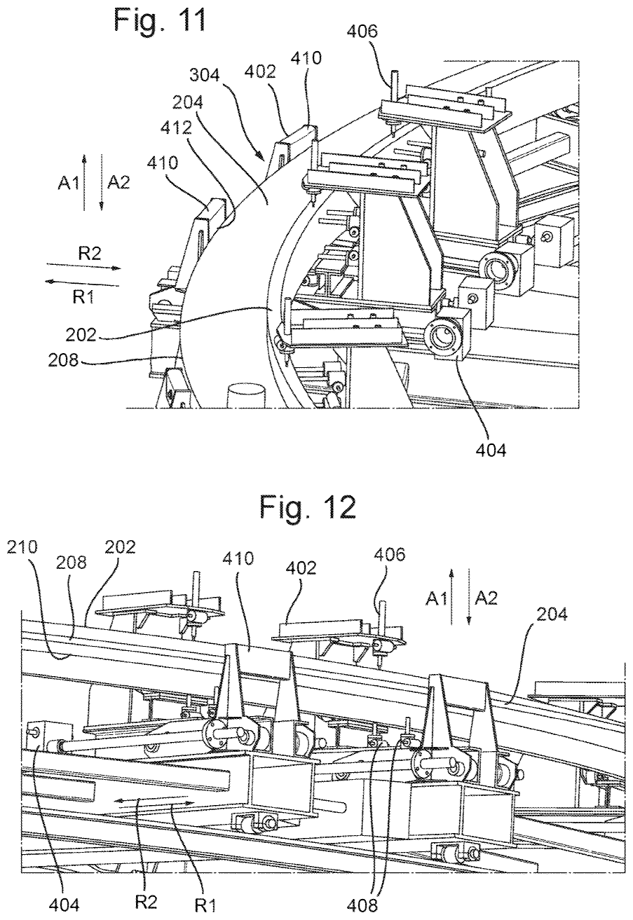

As shown in FIG. 11, the stop member 410 may comprises a sub-element engagement feature 412 configured to engage with a first side edge 208 of a sub-element 202, 204. The first clamping actuator unit 406 may be configured to act on an opposing second side edge 210 of the sub-element 202, 204, either directly or indirectly, and to force the sub-element 202, 204 into engagement with the sub-element engagement feature 412. The sub-element engagement feature 412 may extend away from the surface of the stop member 410, to thereby provide a spacer between the surface of the stop member 410 and the sub-element.

Each workstation 600, 602, 604 may be configured for a different operation on the sub-elements 202, 204. That is, each workstation 600, 602, 604 may be provided with a different tool, configured to perform a different operation to the other tools.

The operations may comprise at least one of material removal to prepare the sub-elements 202, 204 for welding; welding at least two sub-elements 202, 204 together; and/or material removal from the joined sub-elements 202, 204 assembly 222, for example to reduce diameter or add a bevel.

The fabrication system may be further provided with a measurement system 500 configured to measure the positions of predetermined datum points 502 on at least one of the workstations 600, 602, 604.

The manufacture of a support frame 10 for a pressure vessel 12 may be achieved by a method comprising providing a fabrication system 100 and locating a plurality of first sub-elements 202 towards the outer edge 304 of the jig assembly 300 in a circle centred on the rotation axis 302.

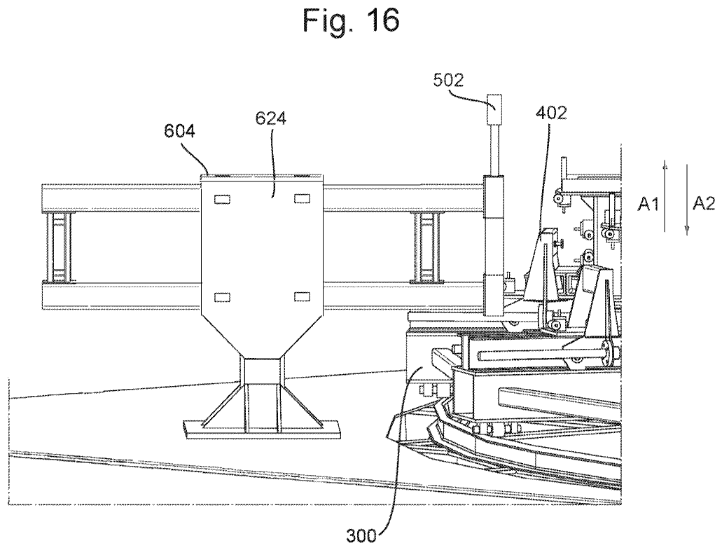

The method may comprise the step of the jig assembly 300 being rotated around the rotation axis 302, so that join/joint regions 212 between the first sub-elements 202 are presented, in turn, to a workstation 602 comprising a material removal tool 624 (as shown in FIG. 16) to prepare the sub-elements 202, 204 for welding (for example to provide a bevel on the edges that will form the joins/joints 212).

The method may comprise the step of rotating the jig assembly 300 around the rotation axis 302 so that joins/joints 212 between the first sub-elements 202 are presented, in turn, to a workstation 600 comprising a welding system 620 (as shown in FIG. 13) to join first sub-elements 202 together to form a circular (i.e. ring shaped) sub-structure 220. The structure 220 is illustrated in FIG. 2.

The method may further comprise locating the second sub-elements 204 relative to the circular (i.e. ring shaped) sub-structure 220 so that the second sub-elements 204 form a circle abutting the circular sub-structure 220, as shown in FIG. 3.

The jig assembly 300 may then be rotated around the rotation axis 302, and the workstation 600 comprising the welding system 620 (as shown in FIG. 13) may be operated to join the second sub-elements 204 to the circular sub-structure 220. They may be joined first by a tack weld and then, in a different process, by a full weld, to form the ring shaped assembly 222 as shown in FIG. 3.

The jig assembly 300 may then be rotated around the rotation axis 302 and the workstation 404 comprising a material removal tool 624 (as shown in FIG. 16) operated to remove material from the assembly 222 of joined sub-elements 202, 204, for example to reduce diameter of the assembly 222 or add a bevel to an edge.

There is thus provided an automated fabrication system 100, and a method of operation of a fabrication system, for the manufacture of a support frame 10 for a pressure vessel 12 from a plurality of sub-elements 202, 204.

The combination of support and positioning provided by the clamping system, which holds and transports elements to be machined and/or welded to a dedicated workstation tool removes the need for a human to execute the operations, reducing risk of harm to the user and increasing repeatability of the machining and weld processes.

A fabrication system according to the present disclosure is able to provide consistent results to the desired quality with less reliance on manual interaction and variation of the process.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A fabrication system for the manufacture of a support frame for a pressure vessel, the support frame being fabricated from a plurality of sub-elements, the fabrication system comprising:
a jig assembly rotatably mounted about a rotation axis, and extending out radially from the rotation axis to an outer edge;
a clamping system mounted on the jig; assembly, the clamping system configured to support each of the sub-elements individually relative to one another, and to allow movement of the sub-elements relative to one another to position them in a predetermined/desirable orientation relative to one another; and
a plurality of workstations arranged around the outer edge of the jig assembly, located and configured to perform operations on the sub-elements to prepare them for being joined to one another, to join them to one another to form an assembly of the sub-elements, and/or to remove material from the sub-element assembly to produce the desired geometry of the support frame;
wherein the plurality of workstations are mounted in a fixed position, the jig assembly being rotatable about the rotation axis relative to the workstations.

2. The fabrication system of claim 1, wherein the jig assembly has a diameter D, with an outer circumference centred on the rotation axis, the sub-elements arranged around the outer circumference of the jig assembly.

3. The fabrication system of claim 1, wherein the plurality of sub-elements includes a first sub-element type and a second sub-element type, and the clamping system is configured to support the first sub-element type and the second sub-element type relative to one another, the first sub-element type and the second sub-element type forming a sector element of the support frame, the clamping system configured to support the sector element.

4. The fabrication system of claim 1, wherein the clamping system comprises a plurality of clamping units spaced apart around a circumference of the jig assembly.

5. The fabrication system of claim 4, wherein each clamping unit comprises a positioning actuator unit, the clamping unit being moveable radially (R1, R2) along the jig assembly relative to the rotation axis by the positioning actuator unit.

6. The fabrication system of claim 4, wherein each clamping unit comprises:
a first clamping actuator unit which is operable to extend in a first axial direction A1 parallel to the rotation axis; and
a second clamping actuator unit which is operable to extend in a second axial direction A2 parallel to the rotation axis;
to thereby clamp a sub-element of the plurality of sub-elements therebetween;
the first axial direction A1 being opposite to the second axial direction A2.

7. The fabrication system of claim 4, wherein each clamping unit comprises:
a stop member provided towards the outer edge of the jig assembly; and
a clamping actuator unit which is operable to extend in a radial direction away from the rotation axis towards the stop member to thereby clamp a sub-element of the plurality of sub-elements between the stop member and the first-clamping actuator unit.

8. The fabrication system of claim 7, wherein:
the stop member comprises a sub-element engagement feature configured to engage with a first side edge of the sub-element of the plurality of sub-elements; and
the clamping actuator unit is configured to act on an opposing second side edge of the sub-element of the plurality of sub-elements, and to force that sub-element into engagement with the sub-element engagement feature.

9. The fabrication system of claim 1, wherein each workstation is configured for a different operation on the sub-elements, the operations comprising at least one of:
material removal to prepare the sub-elements for welding;
welding at least two sub-elements together;
material removal from the joined sub-elements assembly.

10. The fabrication system claim 9, wherein each workstation is provided with a different tool, configured to perform a different operation to any other tool.

11. The fabrication system of claim 10, comprising a measurement system configured to measure the positions of predetermined datum points on at least one of the workstations.

12. A method of manufacture of a support frame for a pressure vessel using a fabrication system, the support frame being fabricated from a plurality of sub-elements, the fabrication system including
a jig assembly rotatably mounted about a rotation axis, and extending out radially from the rotation axis to an outer edge,
a clamping system mounted on the jig assembly, the clamping system configured to support each of the sub-elements individually relative to one another, and to allow movement of the sub-elements relative to one another to position them in a predetermined orientation relative to one another, and
a plurality of workstations arranged around the outer edge of the jig assembly, located and configured to perform operations on the sub-elements to prepare them for being joined to one another, to join them to one another to form an assembly of the sub-elements, and/or to remove material from the sub-element assembly to produce the desired geometry of the support frame,
wherein the plurality of workstations are mounted in a fixed position, the jig assembly being rotatable about the rotation axis relative to the workstations, the method comprising:
locating a plurality of first sub-elements towards the outer edge of the jig assembly in a circle centred on the rotation axis;
rotating the jig assembly around the rotation axis to present, in turn, joins between the located first sub-elements to a workstation comprising a welding system to join the first sub-elements together to form a circular sub-structure;
locating a plurality of second sub-elements relative to the circular sub-structure so that the second sub-elements form a circle abutting the circular sub-structure; and
rotating the jig assembly around the rotation axis, and operating the workstation comprising the welding system to join the second sub-elements to the circular sub-structure.

13. The method of manufacture of claim 12, comprising:
rotating the jig assembly around the rotation, axis; and
operating a workstation comprising a material removal tool to prepare the first and/or second sub-elements for welding.

14. The method of manufacture of claim 12, comprising:
rotating the jig assembly around the rotation axis; and
operating a workstation comprising a material removal tool.

15. A fabrication system for the manufacture of a support frame for a pressure vessel, the support frame being fabricated from a plurality of sub-elements, the fabrication system comprising:
a jig assembly rotatably mounted about a rotation axis, and extending out radially from the rotation axis to an outer edge, the jig assembly having a diameter D, with an outer circumference centred on the rotation axis, the sub-elements arrangeable around the outer circumference of the jig assembly;
a clamping system mounted on the jig assembly, the clamping system configured to support each of the sub-elements individually relative to one another, and to allow movement of the sub-elements relative to one another to position them in a predetermined orientation relative to one another; and
a plurality of workstations arranged around the outer edge of the jig assembly, located and configured to perform operations on the sub-elements;
wherein the plurality of workstations are mounted in a fixed position, the jig assembly being rotatable about the rotation axis relative to the workstations;
wherein the plurality of sub-elements includes a first sub-element type and a second sub-element type, and the clamping system is configured to support the first sub-element type and the second sub-element type relative to one another, the first sub-element type and the second sub-element type forming a sector element of the support frame, the clamping system configured to support the sector element.

16. The fabrication system of claim 15, wherein the clamping system comprises a plurality of clamping units spaced apart around the circumference of the jig assembly, wherein each clamping unit comprises:
a first clamping actuator unit which is operable to extend in a first axial direction A1 parallel to the rotation axis; and
a second clamping actuator unit which is operable to extend in a second axial direction A2 parallel to the rotation axis;
to thereby clamp a sub-element of the plurality of sub-elements therebetween;
the first axial direction A1 being opposite to the second axial direction A2.

17. The fabrication system of claim 15, wherein the clamping system comprises a plurality of clamping units spaced apart around the circumference of the jig assembly, wherein each clamping unit comprises:
a stop member provided towards the outer edge of the jig assembly; and
a clamping actuator unit which is operable to extend in a radial direction away from the rotation axis towards the stop member to thereby clamp a sub-element of the plurality of sub-elements between the stop member and the clamping actuator unit.

18. The fabrication system of claim 17, wherein:
the stop member comprises a sub-element engagement feature configured to engage with a first side edge of the sub-element of the plurality of sub-elements; and
the clamping actuator unit is configured to act on an opposing second side edge of the sub-element of the plurality of sub-elements, and to force that sub-element into engagement with the sub-element engagement feature.

19. The fabrication system of claim 15, wherein each workstation is configured for a different operation on the sub-elements, the operations comprising at least one of:
material removal from individual sub-elements;
welding at least two sub-elements together;
material removal from an assembly of joined sub-elements.

20. The fabrication system claim 19, wherein each workstation is provided with a different tool, configured to perform a different operation to any other tool.
